(19) United States
(12) Patent Application Publication
(10) Pub. No.: US 2019/0368421 A1
(43) Pub. Date: Dec. 5, 2019

(54) GAS TURBINE WITH ROTATING DUCT

(71) Applicant: Rolls-Royce Deutschland Ltd & Co KG, Blankenfelde-Mahlow (DE)

(72) Inventor: Hamish SWEIDAN, Berlin (DE)

(21) Appl. No.: 16/408,720

(22) Filed: May 10, 2019

(30) Foreign Application Priority Data
May 31, 2018 (DE) 10 2018 208 660.5

(51) Int. Cl. F02C 7/18; F01D 25/12; F28D 7/16; F28F 13/06

(52) U.S. Cl. CPC F02C 7/185; F01D 25/12; F28D 7/1684; F05D 2260/213; F05D 2220/32; F05D 2260/201; F28F 13/06

(57) ABSTRACT

A gas turbine has a shaft arranged for driving a compressor and being rotatable with respect to another component, wherein a stream of bleed air from the compressor can flow between the shaft and the other component, wherein a duct is fixed with respect to the shaft such that the stream of bleed air can flow though the duct, wherein the duct surrounds the shaft. A heat exchanger may be arranged in the duct such that the bleed air is cooled by air within the shaft.

This application claims priority to German Patent Application DE102018208660.5 filed May 31, 2018, the entirety of which is incorporated by reference herein.

### DESCRIPTION

The present disclosure relates to gas turbines, in particular to gas turbine engines for aircrafts.

The combustion of fuel in gas turbines creates heat. Various components of the gas turbines, in particular turbine blades and discs, have to withstand correspondingly high temperatures. For this reason, such components commonly are manufactured using specifically stable materials. Such materials may require a complex manufacturing process. Cooling these components may increase the flexibility in the choice of materials and the lifetime. However, if devices for cooling said components are too heavy, the fuel consumption of the gas turbine may be increased.

It is an object to reduce the temperature of cooling air in a gas turbine with a simple and lightweight arrangement.

According to a first aspect there is provided a gas turbine, in particular a gas turbine engine for an aircraft, having a shaft driving a compressor and being rotatable with respect to another component of the gas turbine. The gas turbine is arranged such that a stream of bleed air from the compressor can flow between the shaft and the other component, wherein a duct is fixed with respect to the shaft, for example mounted on the shaft, such that the stream of bleed air can flow though the duct. Therein, it may be provided that the duct (partially or entirely) surrounds the shaft.

By fixing the duct with respect to the shaft, the duct may be rotated with respect to the other component together with the shaft. The stream of bleed air can flow through the duct. Therefore, the stream of bleed air flows between walls that do not rotate with respect to one another. An effect of windage and a resulting increase of the temperature of the bleed air may thus be reduced. By providing the duct, the stream of bleed air may be maintained at a lower temperature by a simple and potentially lightweight device.

The shaft may connect the compressor with a turbine of the gas turbine. The stream of bleed air is an air stream exiting the compressor, in particular at or adjacent to a last stage of the compressor before a combustion equipment of the gas turbine. For example, an outlet or an opening is provided at the compressor, through which bleed air may exit the compressor. The outlet or opening may be arranged at a radially inner wall of the compressor. The gas turbine may be arranged such that after exiting the compressor, the bleed air may flow between the shaft and the other component. The duct is arranged downstream the outlet or opening of the compressor.

The duct may be arranged between the shaft and the other component. The other component may encompass the shaft. Alternatively, the duct may be arranged within the shaft and in fluid connection with a space between the shaft and the other component.

The duct may have an annular shape. For example, the duct extends around an axis and the bleed air may flow through the duct in a direction parallel to the axis.

The duct may extend at least partially along a combustion chamber (e.g., the duct may be surrounded by the combustion chamber. The shaft itself may function as one of the duct walls.

A heat exchanger may be arranged at the duct, the heat exchanger being configured for cooling a stream of bleed air flowing through the duct. The heat exchanger may be adapted for cooling a wall of the duct so that bleed air, streaming though the duct is cooled. The duct may be a part of the heat exchanger. The heat exchanger may be referred to as a rotating internal heat exchanger (RIHX).

The heat exchanger may be supplied with air from within the shaft. The air from within the shaft may be cooler than the bleed air (as in typical gas turbines). The bleed air may be supplied to the duct from outside of the shaft. The air from within the shaft may have a lower pressure than the bleed air. The air from within the shaft may exit the compressor (or an optional other compressor of the gas turbine) at a location upstream the location at which the bleed air exits the compressor.

The heat exchanger may have a cooling-air inlet and a cooling-air outlet. Therein, the cooling-air outlet may be arranged at a larger radius to an axis of rotation of the shaft than the cooling-air inlet. By this, a pumping of the air may be caused what may improve the air flow. The radial difference may be designed such that the pumping effect equals a pressure loss in the heat exchanger. By this, an existing gas turbine may be equipped with the duct and heat exchanger in an easy manner, e.g. without re-balancing pressures within the shaft.

The gas turbine may further comprise nozzles at an outlet of the duct for maintaining a swirl of the bleed air and/or for tuning the swirl of the outlet air.

The shaft may be a high-pressure shaft. When the gas turbine comprises more than one compressor, the shaft may arranged to drive the highest-pressure shaft. Alternatively, the gas turbine may have only one shaft driving a compressor, wherein the duct is fixed to this shaft.

Optionally, the duct is be mounted on a flange of the shaft. This allows a simple installation. In particular, the duct may be mounted between a flange of the shaft and a flange of a disc (or fixed to such a disc) of a turbine of the gas turbine.

The gas turbine may further comprise a combustion chamber, wherein the other component is a casing skin arranged between the combustion chamber and the shaft. The casing skin may be a part of a combustion chamber casing.

Optionally the other component is a windage shield or a part of a windage shield. The windage shield may be arranged adjacent the combustion chamber casing.

The duct may be in fluid connection with at least one turbine blade such as to cool the turbine blade. The turbine blade may be mounted on the shaft, in particular the turbine blade may be mounted on or integrally formed with a disc, wherein the disc is fixed to the shaft. For example, at least one channel in the turbine blade is in fluid connection with the duct. In this manner the turbine blade may be efficiently cooled, and the life of the turbine blade may be improved.

The duct may extend to and be in fluid connection with an inlet of at least one turbine blade. Alternatively, the duct may extend to and be in fluid connection with a cavity defined by at least one static wall (e.g. fixedly connected to the other component), the cavity being in fluid connection with an inlet of at least one turbine blade.

The gas turbine may be an engine adapted for an aircraft. The gas turbine engine may comprise an engine core comprising a turbine, a compressor, and a core shaft connecting the turbine to the compressor (the core shaft and the compressor may be the shaft and the compressor referred to above, or may be another shaft and/or another compressor of the gas turbine engine); a fan located upstream of the engine core, the fan comprising a plurality of fan blades; and a gearbox that receives an input from the core shaft and outputs drive to the fan so as to drive the fan at a lower rotational speed than the core shaft.

Alternatively, the gas turbine is a static gas turbine.

Optionally, the turbine is a first turbine, the compressor is a first compressor, and the core shaft is a first core shaft; the engine core may further comprise a second turbine, a second compressor, and a second core shaft connecting the second turbine to the second compressor; and the second turbine, second compressor, and second core shaft may be arranged to rotate at a higher rotational speed than the first core shaft. The shaft to which the duct is fixed may be the second core shaft.

Arrangements of the present disclosure may be particularly, although not exclusively, beneficial for fans that are driven via a gearbox. Accordingly, the gas turbine engine may comprise a gearbox that receives an input from the core shaft and outputs drive to the fan so as to drive the fan at a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and compressor rotate at the same speed (with the fan rotating at a lower speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) flow from the first compressor.

The gearbox may be arranged to be driven by the core shaft that is configured to rotate (for example in use) at the lowest rotational speed (for example the first core shaft in the example above). For example, the gearbox may be arranged to be driven only by the core shaft that is configured to rotate (for example in use) at the lowest rotational speed (for example only be the first core shaft, and not the second core shaft, in the example above). Alternatively, the gearbox may be arranged to be driven by any one or more shafts, for example the first and/or second shafts in the example above.

In any gas turbine engine as described and/or claimed herein, a combustor may be provided axially downstream of the fan and compressor(s). For example, the combustor may be directly downstream of (for example at the exit of) the second compressor, where a second compressor is provided. By way of further example, the flow at the exit to the combustor may be provided to the inlet of the second turbine, where a second turbine is provided. The combustor may be provided upstream of the turbine(s).

The or each compressor (for example the first compressor and second compressor as described above) may comprise any number of stages, for example multiple stages. Each stage may comprise a row of rotor blades and a row of stator vanes, which may be variable stator vanes (in that their angle of incidence may be variable). The row of rotor blades and the row of stator vanes may be axially offset from each other.

The or each turbine (for example the first turbine and second turbine as described above) may comprise any number of stages, for example multiple stages. Each stage may comprise a row of rotor blades and a row of stator vanes. The row of rotor blades and the row of stator vanes may be axially offset from each other.

Each fan blade may be defined as having a radial span extending from a root (or hub) at a radially inner gas-washed location, or 0% span position, to a tip at a 100% span position. The ratio of the radius of the fan blade at the hub to the radius of the fan blade at the tip may be less than (or on the order of) any of: 0.4, 0.39, 0.38 0.37, 0.36, 0.35, 0.34, 0.33, 0.32, 0.31, 0.3, 0.29, 0.28, 0.27, 0.26, or 0.25. The ratio of the radius of the fan blade at the hub to the radius of the fan blade at the tip may be in an inclusive range bounded by any two of the values in the previous sentence (i.e. the values may form upper or lower bounds). These ratios may commonly be referred to as the hub-to-tip ratio. The radius at the hub and the radius at the tip may both be measured at the leading edge (or axially forwardmost) part of the blade. The hub-to-tip ratio refers, of course, to the gas-washed portion of the fan blade, i.e. the portion radially outside any platform.

The radius of the fan may be measured between the engine centreline and the tip of a fan blade at its leading edge. The fan diameter (which may simply be twice the radius of the fan) may be greater than (or on the order of) any of: 250 cm (around 100 inches), 260 cm, 270 cm (around 105 inches), 280 cm (around 110 inches), 290 cm (around 115 inches), 300 cm (around 120 inches), 310 cm, 320 cm (around 125 inches), 330 cm (around 130 inches), 340 cm (around 135 inches), 350 cm, 360 cm (around 140 inches), 370 cm (around 145 inches), 380 (around 150 inches) cm or 390 cm (around 155 inches). The fan diameter may be in an inclusive range bounded by any two of the values in the previous sentence (i.e. the values may form upper or lower bounds).

The rotational speed of the fan may vary in use. Generally, the rotational speed is lower for fans with a higher diameter. Purely by way of non-limitative example, the rotational speed of the fan at cruise conditions may be less than 2500 rpm, for example less than 2300 rpm. Purely by way of further non-limitative example, the rotational speed of the fan at cruise conditions for an engine having a fan diameter in the range of from 250 cm to 300 cm (for example 250 cm to 280 cm) may be in the range of from 1700 rpm to 2500 rpm, for example in the range of from 1800 rpm to 2300 rpm, for example in the range of from 1900 rpm to 2100 rpm. Purely by way of further non-limitative example, the rotational speed of the fan at cruise conditions for an engine having a fan diameter in the range of from 320 cm to 380 cm may be in the range of from 1200 rpm to 2000 rpm, for example in the range of from 1300 rpm to 1800 rpm, for example in the range of from 1400 rpm to 1600 rpm.

In use of the gas turbine engine, the fan (with associated fan blades) rotates about a rotational axis. This rotation results in the tip of the fan blade moving with a velocity Uₜᵢₚ. The work done by the fan blades 13 on the flow results in an enthalpy rise dH of the flow. A fan tip loading may be defined as dH/Uₜᵢₚ², where dH is the enthalpy rise (for example the 1-D average enthalpy rise) across the fan and Uₜᵢₚ is the (translational) velocity of the fan tip, for example at the leading edge of the tip (which may be defined as fan tip radius at leading edge multiplied by angular speed). The fan tip loading at cruise conditions may be greater than (or on the order of) any of: 0.3, 0.31, 0.32, 0.33, 0.34, 0.35, 0.36, 0.37, 0.38, 0.39 or 0.4 (all units in this paragraph being Jkg⁻¹K⁻¹/(ms⁻¹)²). The fan tip loading may be in an inclusive range bounded by any two of the values in the previous sentence (i.e. the values may form upper or lower bounds).

Gas turbine engines in accordance with the present disclosure may have any desired bypass ratio, where the bypass ratio is defined as the ratio of the mass flow rate of the flow through the bypass duct to the mass flow rate of the flow through the core at cruise conditions. In some arrangements the bypass ratio may be greater than (or on the order of) any of the following: 10, 10.5, 11, 11.5, 12, 12.5, 13, 13.5, 14, 14.5, 15, 15.5, 16, 16.5, or 17. The bypass ratio may be in an inclusive range bounded by any two of the values in the previous sentence (i.e. the values may form upper or lower bounds). The bypass duct may be substantially annular. The bypass duct may be radially outside the core engine. The radially outer surface of the bypass duct may be defined by a nacelle and/or a fan case.

The overall pressure ratio of a gas turbine engine as described and/or claimed herein may be defined as the ratio of the stagnation pressure upstream of the fan to the stagnation pressure at the exit of the highest pressure compressor (before entry into the combustor). By way of non-limitative example, the overall pressure ratio of a gas turbine engine as described and/or claimed herein at cruise may be greater than (or on the order of) any of the following: 35, 40, 45, 50, 55, 60, 65, 70, 75. The overall pressure ratio may be in an inclusive range bounded by any two of the values in the previous sentence (i.e. the values may form upper or lower bounds).

Specific thrust of an engine may be defined as the net thrust of the engine divided by the total mass flow through the engine. At cruise conditions, the specific thrust of an engine described and/or claimed herein may be less than (or on the order of) any of the following: 110 Nkg⁻¹ s, 105 Nkg⁻¹ s, 100 Nkg⁻¹ s, 95 Nkg⁻¹ s, 90 Nkg^{-1 l s,} 85 Nkg⁻¹ s or 80 Nkg⁻¹ s. The specific thrust may be in an inclusive range bounded by any two of the values in the previous sentence (i.e. the values may form upper or lower bounds). Such engines may be particularly efficient in comparison with conventional gas turbine engines.

A gas turbine engine as described and/or claimed herein may have any desired maximum thrust. Purely by way of non-limitative example, a gas turbine as described and/or claimed herein may be capable of producing a maximum thrust of at least (or on the order of) any of the following: 160 kN, 170 kN, 180 kN, 190 kN, 200 kN, 250 kN, 300 kN, 350 kN, 400 kN, 450 kN, 500 kN, or 550 kN. The maximum thrust may be in an inclusive range bounded by any two of the values in the previous sentence (i.e. the values may form upper or lower bounds). The thrust referred to above may be the maximum net thrust at standard atmospheric conditions at sea level plus 15 deg C. (ambient pressure 101.3 kPa, temperature 30 deg C.), with the engine static.

In use, the temperature of the flow at the entry to the high pressure turbine may be particularly high. This temperature, which may be referred to as TET, may be measured at the exit to the combustor, for example immediately upstream of the first turbine vane, which itself may be referred to as a nozzle guide vane. At cruise, the TET may be at least (or on the order of) any of the following: 1400K, 1450K, 1500K, 1550K, 1600K or 1650K. The TET at cruise may be in an inclusive range bounded by any two of the values in the previous sentence (i.e. the values may form upper or lower bounds). The maximum TET in use of the engine may be, for example, at least (or on the order of) any of the following: 1700K, 1750K, 1800K, 1850K, 1900K, 1950K or 2000K. The maximum TET may be in an inclusive range bounded by any two of the values in the previous sentence (i.e. the values may form upper or lower bounds). The maximum TET may occur, for example, at a high thrust condition, for example at a maximum take-off (MTO) condition.

A fan blade and/or aerofoil portion of a fan blade described and/or claimed herein may be manufactured from any suitable material or combination of materials. For example at least a part of the fan blade and/or aerofoil may be manufactured at least in part from a composite, for example a metal matrix composite and/or an organic matrix composite, such as carbon fibre. By way of further example at least a part of the fan blade and/or aerofoil may be manufactured at least in part from a metal, such as a titanium based metal or an aluminium based material (such as an aluminium-lithium alloy) or a steel based material. The fan blade may comprise at least two regions manufactured using different materials. For example, the fan blade may have a protective leading edge, which may be manufactured using a material that is better able to resist impact (for example from birds, ice or other material) than the rest of the blade. Such a leading edge may, for example, be manufactured using titanium or a titanium-based alloy. Thus, purely by way of example, the fan blade may have a carbon-fibre or aluminium based body (such as an aluminium lithium alloy) with a titanium leading edge.

A fan as described and/or claimed herein may comprise a central portion, from which the fan blades may extend, for example in a radial direction. The fan blades may be attached to the central portion in any desired manner. For example, each fan blade may comprise a fixture which may engage a corresponding slot in the hub (or disc). Purely by way of example, such a fixture may be in the form of a dovetail that may slot into and/or engage a corresponding slot in the hub/disc in order to fix the fan blade to the hub/disc. By way of further example, the fan blades maybe formed integrally with a central portion. Such an arrangement may be referred to as a blisk or a bling. Any suitable method may be used to manufacture such a blisk or bling. For example, at least a part of the fan blades may be machined from a block and/or at least part of the fan blades may be attached to the hub/disc by welding, such as linear friction welding.

The gas turbine engines described and/or claimed herein may or may not be provided with a variable area nozzle (VAN). Such a variable area nozzle may allow the exit area of the bypass duct to be varied in use. The general principles of the present disclosure may apply to engines with or without a VAN.

The fan of a gas turbine as described and/or claimed herein may have any desired number of fan blades, for example 16, 18, 20, or 22 fan blades.

As used herein, cruise conditions may mean cruise conditions of an aircraft to which the gas turbine engine is attached. Such cruise conditions may be conventionally defined as the conditions at mid-cruise, for example the conditions experienced by the aircraft and/or engine at the midpoint (in terms of time and/or distance) between top of climb and start of decent.

Purely by way of example, the forward speed at the cruise condition may be any point in the range of from Mach 0.7 to 0.9, for example 0.75 to 0.85, for example 0.76 to 0.84, for example 0.77 to 0.83, for example 0.78 to 0.82, for example 0.79 to 0.81, for example on the order of Mach 0.8, on the order of Mach 0.85 or in the range of from 0.8 to 0.85. Any single speed within these ranges may be the cruise condition. For some aircraft, the cruise conditions may be outside these ranges, for example below Mach 0.7 or above Mach 0.9.

Purely by way of example, the cruise conditions may correspond to standard atmospheric conditions at an altitude that is in the range of from 10000 m to 15000 m, for example in the range of from 10000 m to 12000 m, for example in the range of from 10400 m to 11600 m (around 38000 ft), for example in the range of from 10500 m to 11500 m, for example in the range of from 10600 m to 11400 m, for example in the range of from 10700 m (around 35000 ft) to 11300 m, for example in the range of from 10800 m to 11200 m, for example in the range of from 10900 m to 11100 m, for example on the order of 11000 m. The cruise conditions may correspond to standard atmospheric conditions at any given altitude in these ranges.

Purely by way of example, the cruise conditions may correspond to: a forward Mach number of 0.8; a pressure of 23000 Pa; and a temperature of −55 deg C.

As used anywhere herein, “cruise” or “cruise conditions” may mean the aerodynamic design point. Such an aerodynamic design point (or ADP) may correspond to the conditions (comprising, for example, one or more of the Mach Number, environmental conditions and thrust requirement) for which the fan is designed to operate. This may mean, for example, the conditions at which the fan (or gas turbine engine) is designed to have optimum efficiency.

In use, a gas turbine engine described and/or claimed herein may operate at the cruise conditions defined elsewhere herein. Such cruise conditions may be determined by the cruise conditions (for example the mid-cruise conditions) of an aircraft to which at least one (for example 2 or 4) gas turbine engine may be mounted in order to provide propulsive thrust.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

Embodiments will now be described by way of example only, with reference to the Figures, in which:

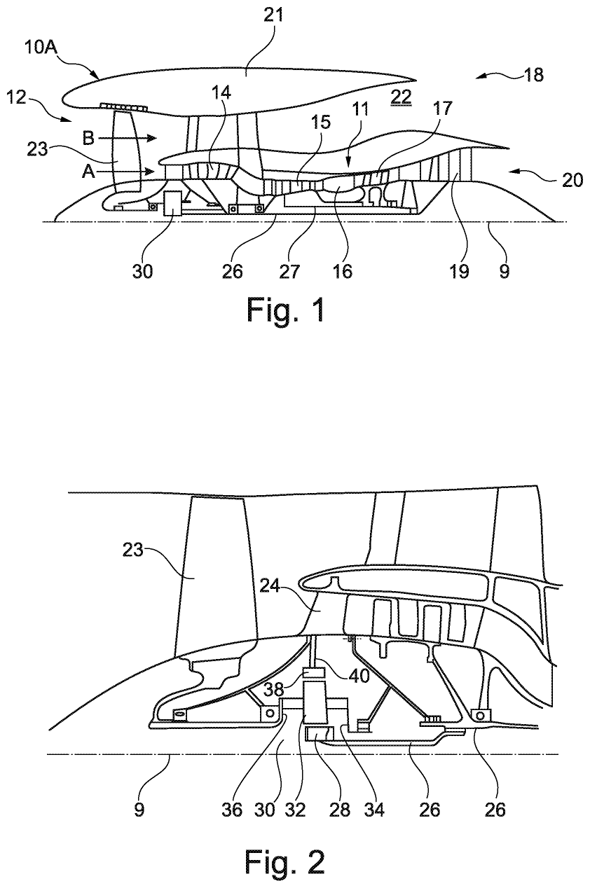

FIG. 1 is a sectional side view of a gas turbine engine;

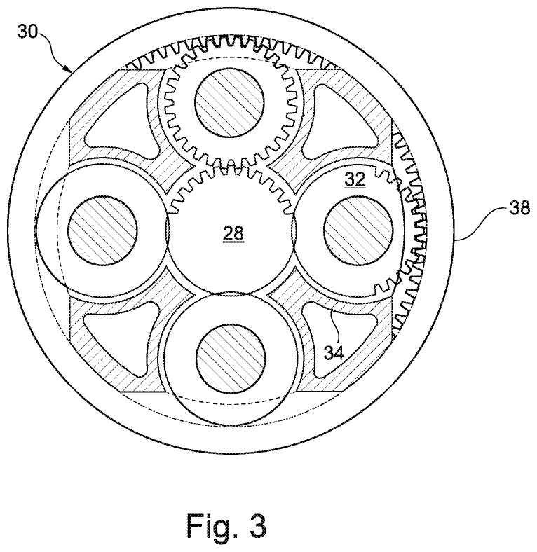

FIG. 2 is a close up sectional side view of an upstream portion of a gas turbine engine;

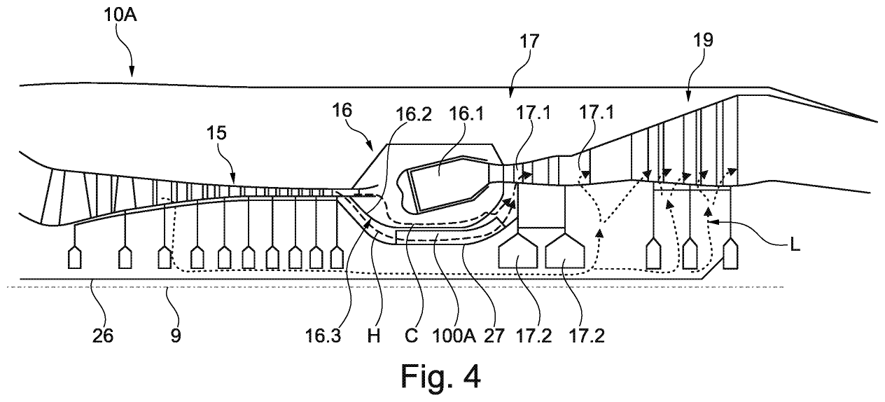

FIG. 3 is a partially cut-away view of a gearbox for a gas turbine engine;

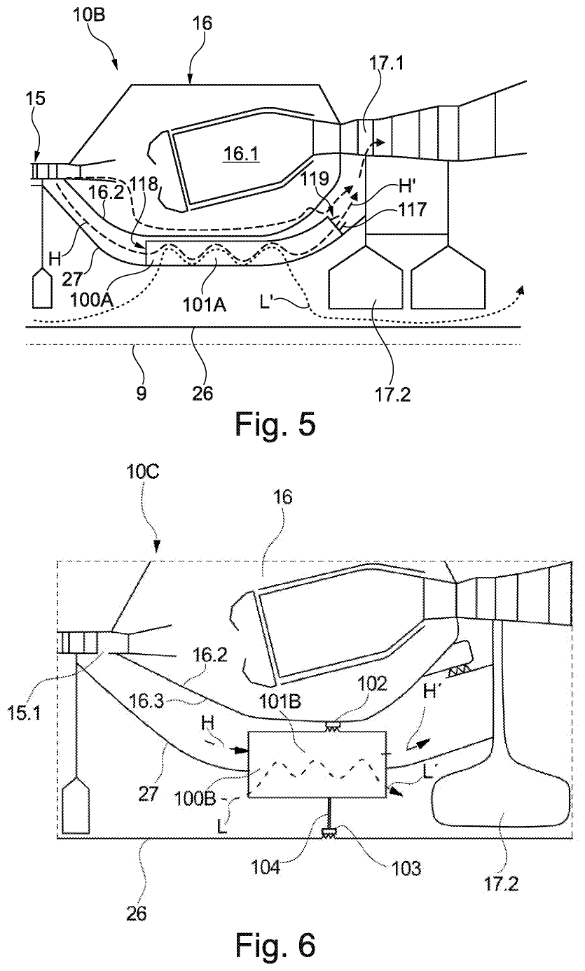

FIG. 4 is a sectional side view of the gas turbine engine, wherein a duct is fixed with respect to a shaft such that a stream of bleed air can flow though the duct;

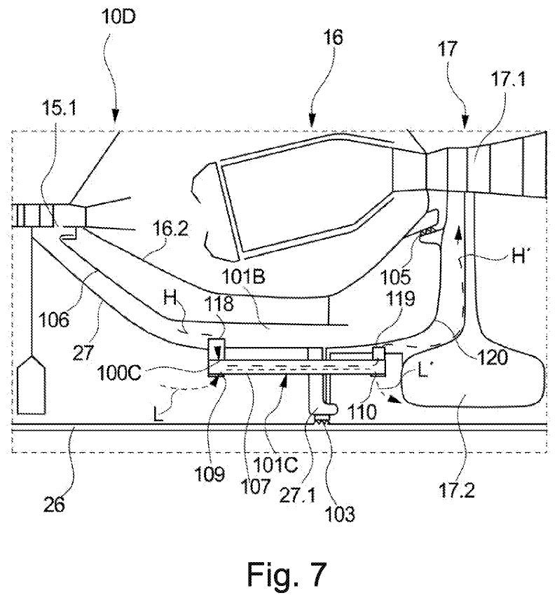

FIG. 5 is a sectional side view of the gas turbine engine according to FIG. 4, wherein the duct is a part of a heat exchanger for cooling the duct;

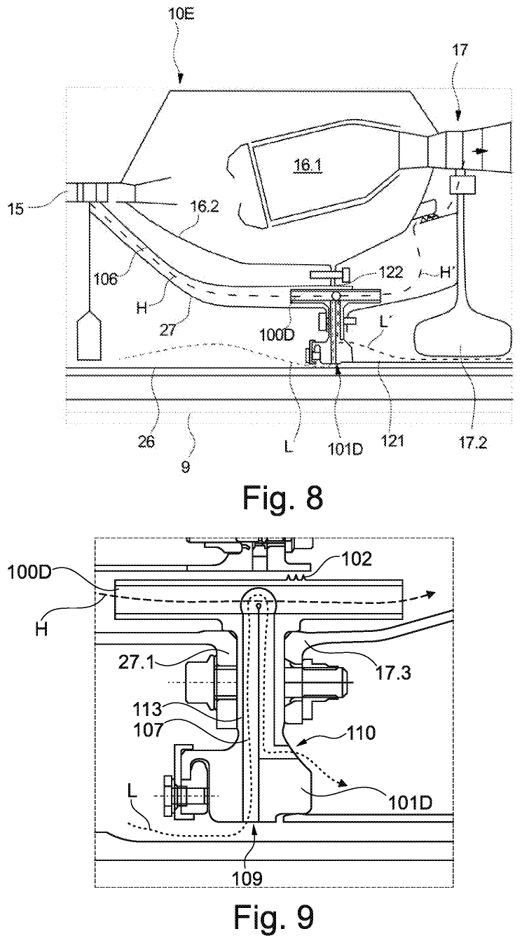

FIG. 6 is a sectional side view of a gas turbine engine, wherein a heat exchanger connects a shaft with a turbine disc and provides a duct, wherein a stream of bleed air can flow though the duct;

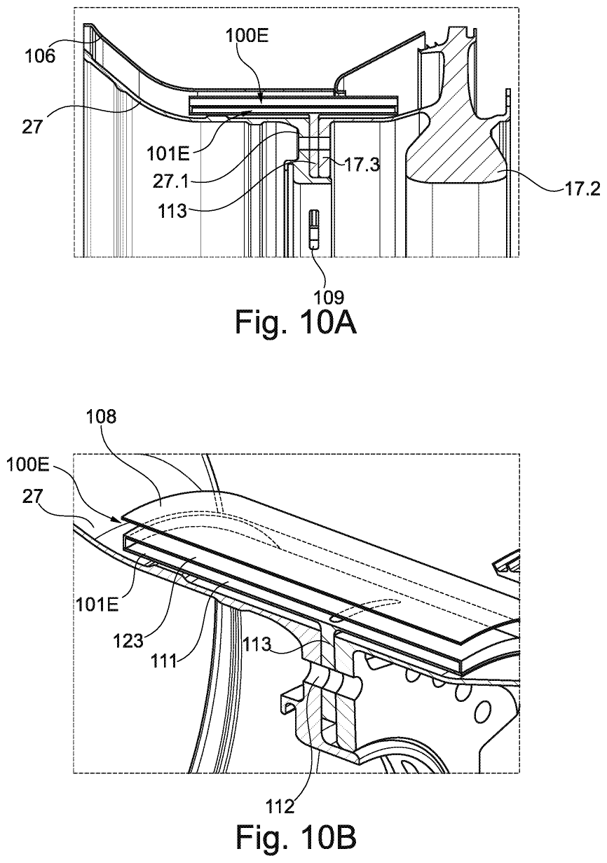

FIG. 7 is a sectional side view of a gas turbine engine, wherein a duct of a heat exchanger is mounted within a shaft and in fluid connection with a space surrounding the shaft, such that a stream of bleed air can flow though the duct;

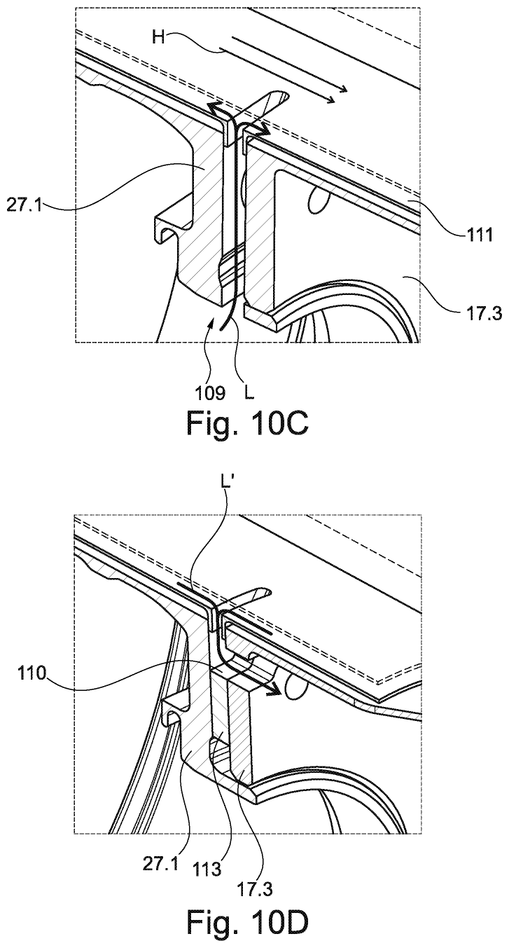

FIG. 8 is a sectional side view of a gas turbine engine, wherein a heat exchanger providing a duct is fixed at a flange of a shaft and arranged such that a stream of bleed air can flow though the duct;

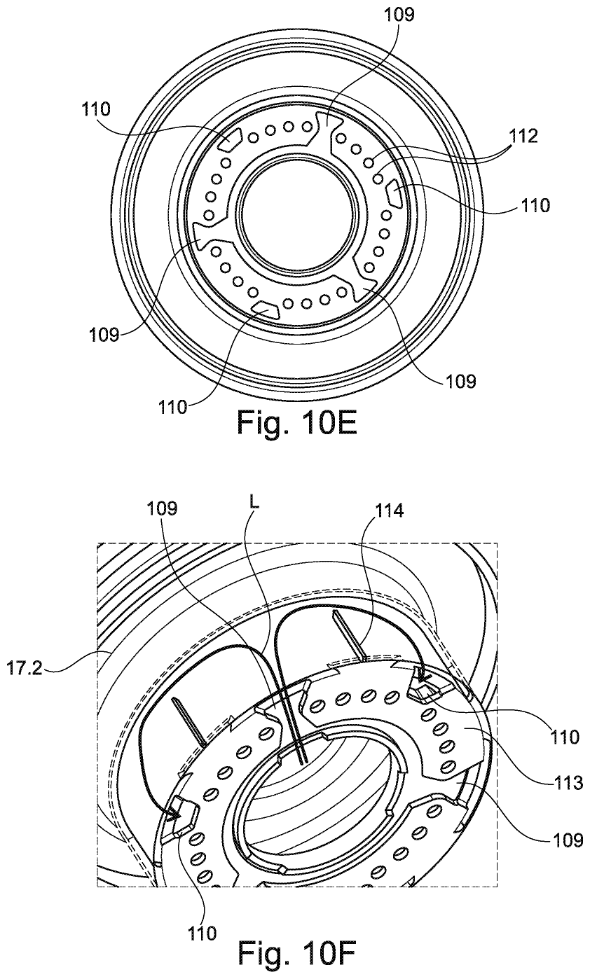

FIG. 9 is a close up sectional side view of the heat exchanger with duct according to FIG. 8;

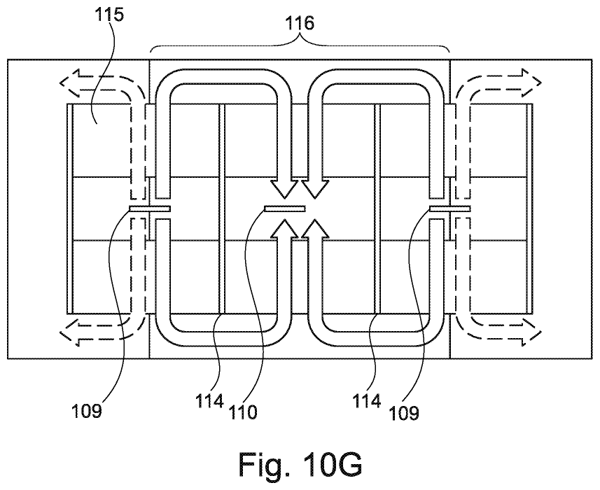

FIGS. 10A to 10G are different views of a shaft and a turbine disc of a gas turbine engine, wherein a heat exchanger providing a duct is fixed at a flange of a shaft and arranged such that a stream of bleed air can flow though the duct;

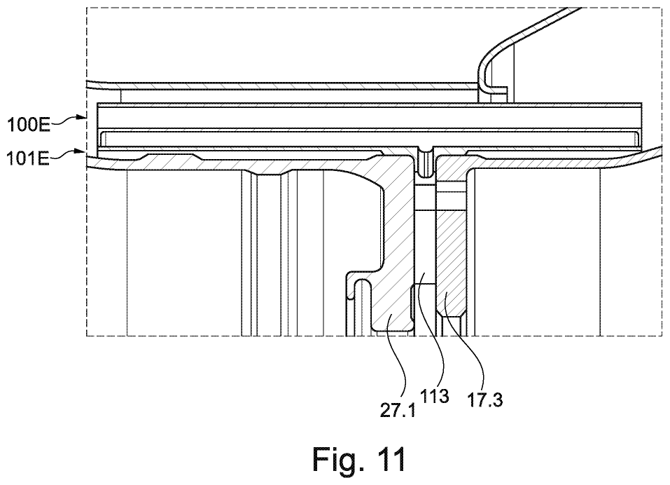

FIG. 11 a sectional side view of flange of a shaft and a heat exchanger with a duct;

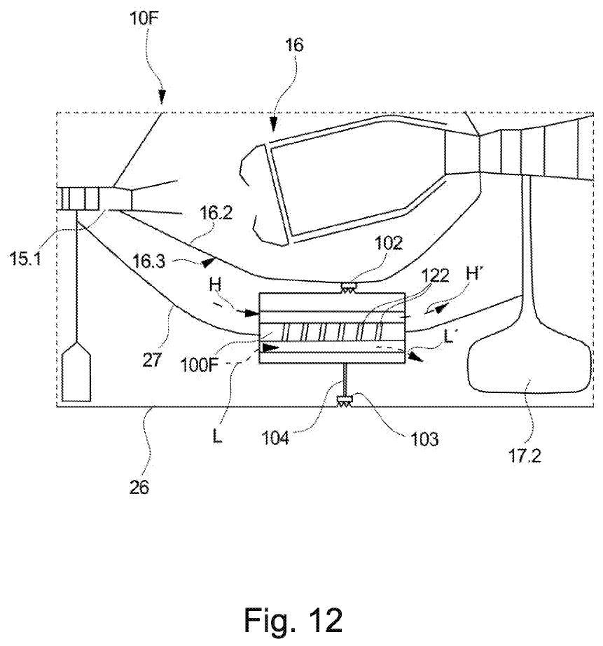

FIG. 12 a sectional side view of a gas turbine engine having a heat exchanger with a duct and a channel being connected with one another via heat pipes;

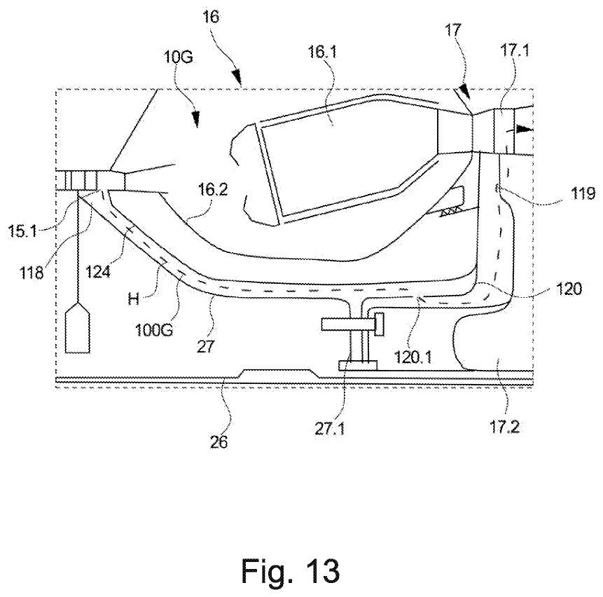

FIG. 13 a sectional side view of a gas turbine engine, wherein a duct is fixed to a shaft and arranged such as to extend from a compressor to a turbine disc of the gas turbine engine.

FIG. 1 illustrates a gas turbine engine 10A having a principal rotational axis 9. The engine 10A comprises an air intake 12 and a propulsive fan 23 that generates two airflows: a core airflow A and a bypass airflow B. The gas turbine engine 10A comprises a core 11 that receives the core airflow A. The engine core 11 comprises, in axial flow series, a low pressure compressor 14, a high-pressure compressor 15, combustion equipment 16, a high-pressure turbine 17, a low pressure turbine 19 and a core exhaust nozzle 20. A nacelle 21 surrounds the gas turbine engine 10A and defines a bypass duct 22 and a bypass exhaust nozzle 18. The bypass airflow B flows through the bypass duct 22. The fan 23 is attached to and driven by the low pressure turbine 19 via a shaft 26 and an epicyclic gearbox 30.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the nozzle 20 to provide some propulsive thrust. The high pressure turbine 17 drives the high pressure compressor 15 by a suitable interconnecting shaft 27. The fan 23 generally provides the majority of the propulsive thrust. The epicyclic gearbox 30 is a reduction gearbox.

An exemplary arrangement for a geared fan gas turbine engine 10A is shown in FIG. 2. The low pressure turbine 19 (see FIG. 1) drives the shaft 26, which is coupled to a sun wheel, or sun gear, 28 of the epicyclic gear arrangement 30. Radially outwardly of the sun gear 28 and intermeshing therewith is a plurality of planet gears 32 that are coupled together by a planet carrier 34. The planet carrier 34 constrains the planet gears 32 to precess around the sun gear 28 in synchronicity whilst enabling each planet gear 32 to rotate about its own axis. The planet carrier 34 is coupled via linkages 36 to the fan 23 in order to drive its rotation about the engine axis 9. Radially outwardly of the planet gears 32 and intermeshing therewith is an annulus or ring gear 38 that is coupled, via linkages 40, to a stationary supporting structure 24.

Note that the terms “low pressure turbine” and “low pressure compressor” as used herein may be taken to mean the lowest pressure turbine stages and lowest pressure compressor stages (i.e. not including the fan 23) respectively and/or the turbine and compressor stages that are connected together by the interconnecting shaft 26 with the lowest rotational speed in the engine (i.e. not including the gearbox output shaft that drives the fan 23). In some literature, the “low pressure turbine” and “low pressure compressor” referred to herein may alternatively be known as the “intermediate pressure turbine” and “intermediate pressure compressor”. Where such alternative nomenclature is used, the fan 23 may be referred to as a first, or lowest pressure, compression stage.

The epicyclic gearbox 30 is shown by way of example in greater detail in FIG. 3. Each of the sun gear 28, planet gears 32 and ring gear 38 comprise teeth about their periphery to intermesh with the other gears. However, for clarity only exemplary portions of the teeth are illustrated in FIG. 3. There are four planet gears 32 illustrated, although it will be apparent to the skilled reader that more or fewer planet gears 32 may be provided within the scope of the claimed invention. Practical applications of a planetary epicyclic gearbox 30 generally comprise at least three planet gears 32.

The epicyclic gearbox 30 illustrated by way of example in FIGS. 2 and 3 is of the planetary type, in that the planet carrier 34 is coupled to an output shaft via linkages 36, with the ring gear 38 fixed. However, any other suitable type of epicyclic gearbox 30 may be used. By way of further example, the epicyclic gearbox 30 may be a star arrangement, in which the planet carrier 34 is held fixed, with the ring (or annulus) gear 38 allowed to rotate. In such an arrangement the fan 23 is driven by the ring gear 38. By way of further alternative example, the gearbox 30 may be a differential gearbox in which the ring gear 38 and the planet carrier 34 are both allowed to rotate.

It will be appreciated that the arrangement shown in FIGS. 2 and 3 is by way of example only, and various alternatives are within the scope of the present disclosure. Purely by way of example, any suitable arrangement may be used for locating the gearbox 30 in the engine 10A and/or for connecting the gearbox 30 to the engine 10A. By way of further example, the connections (such as the linkages 36, 40 in the FIG. 2 example) between the gearbox 30 and other parts of the engine 10A (such as the input shaft 26, the output shaft and the fixed structure 24) may have any desired degree of stiffness or flexibility. By way of further example, any suitable arrangement of the bearings between rotating and stationary parts of the engine (for example between the input and output shafts from the gearbox and the fixed structures, such as the gearbox casing) may be used, and the disclosure is not limited to the exemplary arrangement of FIG. 2. For example, where the gearbox 30 has a star arrangement (described above), the skilled person would readily understand that the arrangement of output and support linkages and bearing locations would typically be different to that shown by way of example in FIG. 2.

Accordingly, the present disclosure extends to a gas turbine engine having any arrangement of gearbox styles (for example star or planetary), support structures, input and output shaft arrangement, and bearing locations.

Optionally, the gearbox may drive additional and/or alternative components (e.g. the intermediate pressure compressor and/or a booster compressor).

Other gas turbine engines to which the present disclosure may be applied may have alternative configurations. For example, such engines may have an alternative number of compressors and/or turbines and/or an alternative number of interconnecting shafts. By way of further example, the gas turbine engine shown in FIG. 1 has a split flow nozzle 20, 22 meaning that the flow through the bypass duct 22 has its own nozzle that is separate to and radially outside the core engine nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area. Whilst the described example relates to a turbofan engine, the disclosure may apply, for example, to any type of gas turbine engine, such as an open rotor (in which the fan stage is not surrounded by a nacelle) or turboprop engine, for example. In some arrangements, the gas turbine engine 10A may not comprise a gearbox 30.

The geometry of the gas turbine engine 10A, and components thereof, is defined by a conventional axis system, comprising an axial direction (which is aligned with the rotational axis 9), a radial direction (in the bottom-to-top direction in FIG. 1), and a circumferential direction (perpendicular to the page in the FIG. 1 view). The axial, radial and circumferential directions are mutually perpendicular.

FIG. 4 shows a part of the gas turbine engine 10A of FIG. 1. The shaft 27 (in the following also referred to as high-pressure shaft) connects the high-pressure turbine 17 with the high-pressure compressor 15. The low-pressure turbine 19 is connected with the low-pressure compressor 14 (not shown in FIG. 4) by means of the shaft 26 (in the following also referred to as low-pressure shaft).

The combustion equipment 16 comprises a combustion chamber 16.1 within which fuel is combusted. The combustion chamber 16.1 is arranged within a combustion chamber casing 16.2. The combustion chamber casing 16.2 has a casing skin 16.3 that faces the high-pressure shaft 27. The casing skin 16.3 and the high-pressure shaft 27 are arranged such that a space is formed therebetween.

When the gas turbine engine 10A is operational, air is bled off from the high-pressure compressor 15, in the following referred to as bleed air H. In the example shown in FIG. 4, the bleed air is bled off from the highest-pressure stage of the high-pressure compressor 15. A stream of bleed air H enters the space between the casing skin 16.3 and the high-pressure shaft 27.

As shown in FIG. 4, the gas turbine engine 10A further comprises a duct 100A. The duct 100A is mounted on the high-pressure shaft 27. The duct 100A is rotatably fixed with respect to the high-pressure shaft 27. Thus, during operation of the gas turbine engine 10A, the duct 100A rotates with respect to static parts of the gas turbine engine 10A, e.g. the combustion equipment 16 and the nacelle 21. The duct 100A has an annular shape. The duct 100A surrounds the high-pressure shaft 27. The duct 100A is arranged between the casing skin 16.3 and the high-pressure shaft 27. The duct 100A is arranged such that the stream of bleed air H entering the space between the casing skin 16.3 and the high-pressure shaft 27 is directed through the duct 100A.

The duct 100A extends along at least a part of the high-pressure shaft 27 along the principal rotational axis 9 in the direction from the high-pressure compressor 15 to the turbine 17. After exiting the duct 100A, the stream of bleed air H is directed towards turbine blades 17.1 of the turbine 17. The turbine blades 17.1 are mounted on or formed in one piece with a respective disc 17.2 of the turbine 17. The turbine blades 17.1 may comprise channels therein which are in fluid connection with the duct 100A. In this way, the turbine blades 17.1 may be efficiently cooled by means of bleed air H.

As indicated by means of an arrow in FIG. 4, another stream of air passes through the combustion chamber casing 16.2. This stream of air, herein referred to as combustion-chamber air C, exits the combustion chamber casing 16.2 in the region of the downstream end of the duct 100A (e.g. though corresponding openings in the combustion chamber casing 16.2), and mixed with the bleed air H, e.g. to increase the amount of air supplied to the turbine blades 17.1. The stream C is optional. The duct 100A is arranged adjacent an inlet of the combustion chamber 16.1. The duct 100A is at least partially arranged upstream the disc 17.2 of the turbine 17. For example, the major part of the duct 100A is arranged upstream the disc 17.2

The casing skin 16.3 and the high-pressure shaft 27 are rotatable with respect to one another. Air streaming between surfaces moving with respect to one another may experience shear and may thus be heated. This effect is referred to as windage. The duct 100A is defined by inner and outer walls that are fixed with respect to one another. By providing the duct 100A, therefore, windage may be reduced. Compared to a gas turbine engine 10A not having the duct 100A, the bleed air may be kept at lower temperatures. The inner wall of the duct 100A may be an outer surface of the shaft 27.

The bleed air H and the combustion-chamber air C are air streams of a high-pressure air system. By means of further arrows, FIG. 4 shows air streams of a low-pressure air system of the gas turbine engine 10A, herein referred to as bore air L. A stream of bore air L exits the high-pressure compressor 15 at a lower-pressure stage compared to the bleed air H (alternatively or additionally, the bore air at least partially comes the low-pressure compressor 14). Thus, the bore air L has a lower pressure than the bleed air H. The bore air L flows within the high-pressure shaft 27. The bore air L flows within a space outside of the low-pressure shaft 26. The bore air L flows from the high-pressure compressor 15 to turbine stages downstream the turbine stages supplied with bleed air H. As can be seen in FIG. 4, at least one stream of bore air L (or in general at least one stream of air from within the high-pressure shaft 27) flows through inner bores of compressor discs and of turbine discs 17.2.

Because the duct 100A is mounted on the high-pressure shaft 27, the duct 100A may be referred to as a rotating duct 100A.

FIG. 5 shows a gas turbine engine 10B which differs from the gas turbine engine 10A according to FIG. 4 in that the duct 100A is coupled with a heat exchanger 101A. According to FIG. 5, the duct 100A is a part of a heat exchanger 101A. The heat exchanger 101A is arranged such as to exchange heat between a fluid flowing through the duct 101A and another fluid supplied to the heat exchanger 101A. The heat exchanger 101A is arranged such that it may be supplied and flown through by bore air L. In the operation of the gas turbine engine 10B, a stream of bore air L enters the heat exchanger 101A with a first temperature. The bore air L receives heat from bleed air H (having a higher temperature than the bore air L due to the higher compression) flowing through the duct 100A, and exits the heat exchanger 101A with a second temperature higher than the first temperature. Correspondingly, bleed air H enters through an inlet 118 of the duct 100A at a third temperature and exits the duct 100A through an outlet 119 with a fourth temperature. Therein, the fourth temperature is lower than the third temperature. Therefore, cooled bleed air H′ exits the duct 100A, and warmed bore air L′ exits the heat exchanger 101A.

The heat exchanger 101A is arranged on the outer circumference of the high-pressure shaft 27. One or more inlets and outlets to the inner space of the high-pressure shaft 27 are provided to receive and discharge bore air L, L′.

The cooled bleed air H′ may efficiently cool the turbine blades 17.1. A portion or all of the blade cooling air may be passed through the duct 100A for being cooled by the heat exchanger 101A. Furthermore, the cooled bleed air H′ may efficiently cool the rim and diaphragm of the turbine discs 17.2. The warmed bore air L′, on the other hand, may maintain an inner bore of one or more turbine discs 17.2 at a temperature closer to the temperature of the diaphragm and the turbine blades 17.1. Therefore, temperature gradients and hence thermally induced stresses across one or more turbine discs 17.2 may be decreased. This can lead to an improved lifetime of the turbine discs 17.2. Alternatively or in addition, lighter discs 17.2 may be used, e.g. made of less material.

By use of the rotating duct 100A, the swirl of the bleed air H may be maintained. FIG. 5 further shows that the duct 100A comprises nozzles at the outlet 119, wherein the nozzles are adapted for tuning the swirl of the outlet air. By this, it is possible to optimise the swirl to minimise windage in subsequent cavities.

Because the heat exchanger 101A is mounted on the high-pressure shaft 27, the heat exchanger 101A may be referred to as a rotating heat exchanger 101A or rotating internal heat exchanger 101A.

While heat may also be exchanged between bleed air H and bore air L across the high-pressure shaft 27, the heat exchanger 101A is adapted to specifically guide air flows for a dedicated heat exchange. Therefore, by means of the heat exchanger 101A, heat exchange between bleed air H and bore air L may be improved.

Turning now to FIG. 6, a gas turbine engine 10C with another heat exchanger 101B with a duct 100B for bleed air H for cooling the bleed air H with bore air L will be described. The heat exchanger 101B having the duct 100B is partially arranged outside of the high-pressure shaft 27, and partially arranged inside the high-pressure shaft 27. The heat exchanger 101B connects the high-pressure shaft 27 with a turbine disc 17.2.

A baffle 104 extends radially inward from the heat exchanger 101B. An inner seal 103 seals the baffle 104 with respect to the low-pressure shaft 26 so that the bore air L is directed through the heat exchanger 101B.

An outer seal 102 seals the heat exchanger 101B with respect to the casing skin 16.3 of the combustion chamber casing 16.2 so that the bore air H is directed though the duct 100B.

FIG. 6 further shows an opening 15.1 adjacent to the last compressor disc of the high-pressure compressor. The opening 15.1 connects the high-pressure compressor 15 with the space between the (high-pressure) shaft 27 and the combustion chamber casing 16.2. The bleed air H flows though the opening 15.1.

FIG. 7 shows a gas turbine engine 10D similar to the gas turbine engine 10C according to FIG. 6, so in the following only the differences will be explained. The gas turbine engine 10D has a windage shield 106 that covers the combustion chamber casing 16.2. Bleed air H flows in the space between the windage shield 106 and the high-pressure shaft 27.

A heat exchanger 101C having a duct 100C for the bleed air H is mounted on the high-pressure shaft 27 and arranged inside the high-pressure shaft 27. The duct 100C is connected to the space between the windage shield 106 and the high-pressure shaft 27 via an inlet 118.

FIG. 7 further shows a channel 107 of the heat exchanger 101C having an inlet 109 and an outlet 110 for the bore air L. In the sectional view according to FIG. 7, the channel 107 extends in parallel to the duct 100C. The duct 100C and the channel 107 both extend through a flange 27.1 of the high-pressure shaft 27. An inner seal 103 seals the flange 27.1 of the high-pressure shaft 27 with respect to the low-pressure shaft 26. A cover plate 120 covers the disc 17.2 of the high-pressure turbine 17 adjacent the combustion chamber 16. A seal 105 seals the cover plate 120 with respect to the combustion chamber casing 16.2. On the other hand, the cover plate 120 is tightly mounted on the flange 27.1 of the high-pressure shaft 27. The outlet 119 of the duct 100C connects the duct 100C with a space between the cover plate 120 and the disc 17.2, so that cooled bleed air H′ can flow through this space towards the turbine blades 17.1, indicated by an arrow in FIG. 7.

FIGS. 8 and 9 show another gas turbine engine 10E similar to the gas turbine engine 10D according to FIG. 7. In contrast to the gas turbine engine 10D according to FIG. 7, a heat exchanger 101D having a duct 100D for the bleed air H is mounted on the high-pressure shaft 27 such that the duct 100D is arranged outside the shaft 27.

The duct 100D has an annular shape and extends around the high-pressure shaft 27. The duct 100D is arranged between the windage shield 106 and the high-pressure shaft 27. An outer seal 102 seals the duct 100D with respect to the windage shield 106.

A flange 113 (or in general a plate) of the heat exchanger 101D extends radially inward from the duct 100D. The flange 113 is mounted between a flange 27.1 of the high-pressure shaft 27 and a flange 17.3 of the high-pressure turbine 17. Thus, the high-pressure shaft 27 and the high-pressure turbine 17 are mounted to one another via a part of the heat exchanger, in the present example, the flange 133. At least one channel 107 is provided within the flange 113. The channel 107 extends from an inlet 109 in a radial direction towards the duct 100D. The inlet 109 is arranged at an inner circumferential surface of the flange 113. A portion of the channel 107 extends inside the duct 100D (wherein the channel 107 and the duct 100D are not in fluid connection). Within the duct 100D, the channel 107 makes a turn and extends again in radial direction. An axial bore defines an outlet 110 of the channel 107.

Bleed air H and bore air L may exchange heat via the U-shaped portion of the channel 107 inside the duct 100D. The U-shaped turn illustrates a simplified heat exchange surface, which could take on a much more complicated form to further improve heat transfer.

The inlet 109 of the channel 107 is arranged at a first radius with respect to the principal rotational axis 9. The outlet 110 of the channel 107 is arranged at a second radius with respect to the principal rotational axis 9. The second radius is larger than the first radius. This may provide a pumping effect by rotation of the high-pressure shaft 27. The pumping effect may increase a flow of bore air L.

The gas turbine engine 10E further comprises an air guide tube 121. The air guide tube 121 extends from the flange 113 of the heat exchanger 101D and covers inner circumferences of the discs 17.2 of the high-pressure turbine 17. The air guide tube 121 is sealed against the low pressure shaft 26 by an inner seal 103, so that warmed bore air L′ flows between the air guide tube 121 and the inner bores of the discs 17.2 and further inside the high-pressure turbine 17.

FIGS. 10A to 10G show the high-pressure shaft 27 and a disc 17.2 of the high-pressure turbine 17 of a gas turbine engine similar to the gas turbine engine 10E according to FIGS. 8 and 9.

A duct 100E is arranged between the high-pressure shaft 27 and another engine component with respect to which the high-pressure shaft 27 is rotatable. In the example according to FIGS. 10A to 10G, the other engine component is the windage shield 106.

The duct 100A is part of a heat exchanger 101E. In a cross-sectional view, the heat exchanger 101E has a T-shape. The heat exchanger 101E comprises an annular chamber 111. The annular chamber 111 is surrounded by the duct 100E. The annular chamber 111 and the duct 100E are separated from one another by a cylindrical wall 123. The duct 100E is defined by this inner cylindrical wall 111 and another, outer cylindrical wall 108. The duct 100E is arranged so as to be flown through by bleed air H, H′. The annular chamber 111 is arranged so as to be flown through by bore air L, L′.

The flange 113 of the heat exchanger 101E extends radially inward from the annular chamber 111. The flange 113 is arranged between a flange 27.1 of the high-pressure shaft 27 and a flange 17.3 of the disc 17.2. A plurality of through bores 112 through the three flanges serve for fixing the flanges to one another, e.g. by screws.

The annular chamber 111 is in fluid connection with a plurality of inlets 109 and outlets 110 for bore air L, L′. The inlets 109 are arranged at an inner circumference of an axial protrusion of the flange 27.1 of the high-pressure shaft 27. The inlets 109 (in the present example three inlets 109 are provided) are connected with one another by an annular chamber defined by the three flanges. The inlets 109 connect an inner space of the high-speed shaft 27 with the annular chamber 111 so that bore air L may flow inside the annular chamber 111.

A plurality of outlets 110 (in the present example, three outlets 110) connect the annular chamber 111 with an inner space of the turbine disc 17.2. Warmed bore air L′ may flow out of the annular chamber 111 through the outlets 110. The outlets 110 are arranged at a lateral surface of the flange 17.3 of the turbine disc 17.2. The outlets 110 are arranged at a larger radius than the inlets 109.

As particularly shown in FIGS. 10F and 10G (the latter figure showing a part of the annular chamber 111 in an unrolled representation), a plurality of dividers 114 divide the space within the annular chamber 111 to define passages for bore air L flowing through the annular chamber 111 for an efficient heat exchange with bleed air H. The inlets 109, outlets 110 and dividers 114 define three sectors 116 of the heat exchanger 101E. As particularly shown in FIGS. 10C, 10D and 10G, within sections of the annular chamber 111, the bore air L flows in parallel to the bleed air H, while in other sections, bore air L flows in opposite direction than the bleed air H. After entering through the inlets 109, the bore air L may flow in both directions.

Optional fins 115 improve the heat exchange. For example, the fins 115 are arranged on an inner circumference of the cylindrical wall 123. Correspondingly, fins may be arranged inside the duct 100E.

FIG. 11 shows an alternative arrangement with respect to FIGS. 10A to 10G, wherein the flange 27.1 of the high-pressure shaft 27 does not have an axial protrusion covering inner circumferences of the flanges 113, 17.2 of the heat exchanger 101E and the turbine disc 17.2.

FIG. 12 shows a gas turbine engine 10F similar to the gas turbine engine 10C according to FIG. 6. According to FIG. 12, a plurality of heat pipes 122 are arranged to exchange heat between bleed air H flowing through a duct 100F and bore air L flowing through a channel 107. The duct 110F is arranged outside of the high-pressure shaft 27 and the channel 107 is arranged inside of the high-pressure shaft 27. The heat pipes may be centrifugally pumped.

FIG. 13 shows a gas turbine engine 10G similar to the gas turbine engine 10D according to FIG. 7. According to FIG. 13, a duct 100G is formed by a wall 125 mounted on the high-pressure shaft 27 and a cover plate 120 mounted to the high-pressure shaft 27. The wall 124 surrounds the high-pressure shaft 27. The wall 124 has at least one cylindrical portion. The duct 100G extends from an opening 15.1 for bleed air H at the high-pressure compressor 15 to an inlet of a turbine blade 17.1 mounted on the disc 17.2. An inlet 118 of the duct 100G is arranged adjacent the opening 15.1 of the high-pressure compressor 15. The duct 100G extends along the combustion chamber 16.1. The duct 100G covers the high-pressure shaft 27 along its axial length.

The wall 124 is sealed against, formed in one piece and/or mounted to the cover plate 120. The cover plate 120 covers an outer circumferential surface of the disc 17.2. The cover plate 120 comprises one or more openings 120.1 for the bleed air H. An outlet 119 of the duct 100G is arranged at or adjacent to an inlet of the turbine blade 17.1. The duct 100G extends from the high-pressure compressor 15 to the high-pressure turbine 17.

All of the blade cooling air from the opening 15.1 of the high-pressure compressor 15 flows through the duct 100G. The gas turbine engine 10G comprises no pre-swirl nozzle for that blade cooling air. The stream of bleed air H does not re-enter a static cavity on its way to the turbine blade 17.1. In this way it is possible to minimize windage losses even further.

While examples of gas turbine engines have been shown having a high-pressure shaft 27 and a low-pressure shaft 26, it will be understood that the ducts and heat exchangers as described above may alternatively be used in gas turbine engines having only one shaft (the duct and heat exchanger may then be mounted on this shaft) or more than two shafts (the duct and heat exchanger may then be mounted, e.g., on the shaft driving the highest pressure compressor), the gas turbine engines described above may, or may not comprise a gearbox 30.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A gas turbine having a shaft arranged for driving a compressor and being rotatable with respect to another component, wherein a stream of bleed air from the compressor can flow between the shaft and the other component, wherein a duct is fixed with respect to the shaft such that the stream of bleed air can flow though the duct, wherein the duct surrounds the shaft.

2. The gas turbine according to claim 1, wherein the duct is arranged between the shaft and the other component.

3. The gas turbine according to claim 1, wherein the duct has an annular shape.

4. The gas turbine according to claim 1, wherein the duct extends at least partially along a combustion chamber.

5. The gas turbine according to claim 1, further comprising a heat exchanger comprising the duct, the heat exchanger being configured for cooling a stream of bleed air flowing through the duct.

6. The gas turbine according to claim 5, wherein the heat exchanger is supplied with air from within the shaft, the air being cooler than the bleed air.

7. The gas turbine according to claim 5, wherein the heat exchanger has a cooling-air inlet and a cooling-air outlet, wherein the cooling-air outlet is arranged at a larger radius to an axis of rotation of the shaft than the cooling-air inlet.

8. The gas turbine according to claim 1, further comprising nozzles at an outlet of the duct for tuning the swirl of the outlet air.

9. The gas turbine according to claim 1, wherein the shaft is a high-pressure shaft.

10. The gas turbine according to claim 1, wherein the duct is mounted on a flange of the shaft.

11. The gas turbine according to claim 1, further comprising a combustion chamber, wherein the other component is a casing skin between the combustion chamber and the shaft.

12. The gas turbine according to claim 1, further comprising a combustion chamber, wherein the other component is a windage shield adjacent a combustion chamber casing of the combustion chamber.

13. The gas turbine according to claim 1, wherein the duct is in fluid connection with at least one turbine blade for cooling the turbine blade.

14. The gas turbine according to claim 13, wherein the duct extends to and is connected with an inlet of at least one turbine blade, or extends to and is connected with a cavity defined by at least one static wall, the cavity being in fluid connection with an inlet of at least one turbine blade.

15. The gas turbine engine according to claim 1, for an aircraft, comprising:
an engine core comprising a turbine, a compressor, and a core shaft connecting the turbine to the compressor;
a fan located upstream of the engine core, the fan comprising a plurality of fan blades; and
a gearbox that receives an input from the core shaft and outputs drive to the fan so as to drive the fan at a lower rotational speed than the core shaft.

16. The gas turbine engine according to claim 15, wherein:
the turbine is a first turbine, the compressor is a first compressor, and the core shaft is a first core shaft;
the engine core further comprises a second turbine, a second compressor, and a second core shaft connecting the second turbine to the second compressor; and
the second turbine, second compressor, and second core shaft are arranged to rotate at a higher rotational speed than the first core shaft.
